(19) United States
(12) Patent Application Publication
(10) Pub. No.: US 2026/0094979 A1
(43) Pub. Date: Apr. 2, 2026

(54) Fast-Wiring Device and Electrical Accessories

(71) Applicant: Ze Chen, Huizhou (CN)

(72) Inventor: Ze Chen, Huizhou (CN)

(73) Assignee: Ze Chen, Huizhou (CN)

(21) Appl. No.: 19/171,130

(22) Filed: Apr. 4, 2025

(30) Foreign Application Priority Data
Sep. 27, 2024 (CN) 202411366410.8

(51) Int. Cl. H01R 4/48

(52) U.S. Cl. CPC H01R 4/48

(57) ABSTRACT

This invention discloses a fast-wiring device and an electrical accessory. The fast-wiring device comprises a housing comprising a wire insertion port for receiving a wire; a conductive element mounted in the housing near the wire insertion port, the conductive element configured to contact the wire; and an elastic element mounted in the housing opposite to the conductive element, the elastic element comprising an elastic inclined arm comprising an edge, the edge configured to press against the conductive element when the wire is not inserted, and the edge configured to press the wire against the conductive element when the wire is inserted.

### CROSS-REFERENCE TO RELATED APPLICATIONS

This continuation-in-part application claims the benefit of priority to Chinese Patent Application No. 202411366410.8, filed on Sep. 27, 2024, which is incorporated herein by reference in its entirety.

### TECHNICAL FIELD

This invention relates to a fast-wiring device for power cables, and also pertains to electrical accessories that utilize the device.

### BACKGROUND

Traditional electrical accessories that require connection to power cables, such as power sockets, circuit breakers, and switches, typically use screws to press the connection ends of the power cables onto copper terminals. Such connection structures are complex to operate, have low connection efficiency, and the connection quality can vary greatly depending on an operator's expertise, skill, and dedication. For example, when an average user purchases a power socket and installs it themselves, poor connections at the cable terminals often occur, leading to high resistance at the connection point. Prolonged use may cause overheating at the connection to the power cables and damage the sockets.

### SUMMARY

One of the technical problems the present invention aims to solve is to provide a fast-wiring device that overcomes the drawbacks of complex wiring operations, low wiring efficiency, and poor connection quality due to human factors in the existing technology.

A second technical problem this invention aims to solve is to provide electrical accessories that overcome the drawbacks of complex wiring operations, low wiring efficiency, and poor connection quality due to human factors in the existing technology.

A fast-wiring device can include a housing comprising a wire insertion port for receiving a wire; a conductive element mounted in the housing near the wire insertion port, the conductive element configured to contact the wire; and an elastic element mounted in the housing opposite to the conductive element, the elastic element comprising an elastic inclined arm comprising an edge, the edge configured to press against the conductive element when the wire is not inserted, and the edge configured to press the wire against the conductive element when the wire is inserted.

A fast-wiring device can include an elastic element comprising a first bend configured to generate elastic clamping force; and a supporting edge; wherein the first bend connects an elastic inclined arm with the supporting edge.

A fast-wiring device can include a housing comprising a supporting wall and a bend mounting position, a supporting edge abutting the supporting wall, and a first bend abutting the bend mounting position.

A fast-wiring device can include an elastic element comprising a second bend and an extending edge, a second bend connecting a supporting edge to the extending edge, and the extending edge is electrically connected to a conductive element.

A fast-wiring device can include an elastic element comprising a third bend in an elastic inclined arm, the elastic inclined arm is configured to apply an elastic clamping force against a conductive element, and the third bend is bent at an angle that increases a wedge angle formed between the elastic inclined arm and the conductive element.

A fast-wiring device can include a first bend further comprising an extending edge electrically connected to a conductive element, an elastic element comprising a second bend in an elastic inclined arm, an elastic inclined arm is configured to apply an elastic clamping force against the conductive element, and the second bend is bent at an angle that increases a wedge angle formed between the elastic inclined arm and the conductive element.

A fast-wiring device can include a conductive element provided with an arc surface, and wherein the arc surface is configured to mate with a surface of a wire when the wire is inserted.

A fast-wiring device can include a clamping-release mechanism mounted on a housing such that a conductive element is between an elastic element and the clamping-release mechanism, and the clamping-release mechanism is configured to press the elastic element away from the conductive element; wherein the clamping-release mechanism comprises a button and wherein the button comprises: a hinged end hinged to the housing, and a pushing end fitted against an elastic inclined arm, wherein, when the button is pressed, the pushing end lifts the elastic inclined arm away from the conductive element.

A fast-wiring can include a clamping-release mechanism mounted on a housing such that a conductive element is between an elastic element and the clamping-release mechanism, and the clamping-release mechanism is configured to press the elastic element away from the conductive element; wherein the clamping-release mechanism comprises a button, and wherein the button comprises a pressing guide part, the pressing guide part fitting with a guide slot in the housing; and a pushing part, the pushing end fitted against an elastic inclined arm, wherein, the pushing part is configured to lift the elastic inclined arm way from the conductive element when the button is pressed.

A fast-wiring drive can include an operation hole in a housing, wherein the operation hole is configured to receive a tool for pushing an elastic inclined arm away from a conductive element.

An electrical accessory can include a fast-wiring device.

An electrical accessory including a fast-wiring device can include a power socket, a circuit breaker, lamp, or a power switch.

An electrical accessory can include a live wire hole, ground wire hole, or neutral wire hole incorporating a fast-wiring device.

A fast-wiring device can include an arc surface having a radius value that is, or is approximately, one half of the diameter of a wire.

A fast-wiring device can include a radius of a wire exceeding the radius of an arc surface, and wherein the arc surface and the wire form two lines of electrical contact.

A fast-wiring device can include a housing comprising a wire insertion port; a conductive element mounted in the housing, the conductive element configured to contact a wire inserted through the wire insertion port; and an elastic element comprising an elastic inclined arm, the elastic element mounted in the housing; wherein the conductive element is opposite to the elastic element, and wherein the elastic inclined arm presses elastically against the conductive element when a wire is not inserted, and wherein the elastic inclined arm elastically presses the wire against the conductive element when the wire is present.

A fast-wiring device can include an elastic element comprising a supporting edge; and a bend between the supporting edge and an elastic inclined arm; wherein the supporting edge rests against a supporting wall of a housing and the bend generates an elastic clamping force against a wire when the wire is present.

A fast-wiring device can include an elastic element comprising an extending edge; and a bend between the extending edge and an inclined arm, wherein the extending edge is electrically connected to a conductive element and the bend elastically presses a wire against the conductive element when the wire is present.

A fast-wiring device can include a clamping-release mechanism configured to lift an elastic element.

A fast-wiring device can include a housing comprising a wire insertion port for receiving a wire, the wire insertion port having a wire insertion direction; a conductive element mounted in the housing for contacting the wire once the wire has been received; and an elastic element comprising an elastic inclined arm; wherein the elastic element is mounted in the housing opposite to the conductive element, wherein the elastic inclined arm presses against the conductive element when a wire is not inserted, and wherein the elastic inclined arm presses the wire against the conductive element when the wire has been inserted, and wherein the elastic inclined arm forms a wedge shape with the conductive element along the wire insertion direction of the wire insertion port.

Compared with existing technology, the advantages of implementing the fast-wiring device and electrical accessories of this invention are:
1. Wiring is fast and reliable by simply inserting the connection end of a power cable into the insertion port, with simple operation and high efficiency.
2. Releasing the wire is simple and convenient by pressing the clamping-release mechanism and pulling out the wire.
3. The quality of the wiring is determined by the structure of the fast-wiring device and is not affected by human factors, ensuring stable and reliable connections.
4. The structure is simple, with low implementation costs.

### BRIEF DESCRIPTION OF THE DRAWINGS

FIG. 1 is a front view of an embodiment of an electrical accessory incorporating the fast-wiring device according to the present invention.

FIG. 2A and FIG. 2B are enlarged sectional views along L/N-L/N of FIG. 1, showing the state of the fast-wiring device according to one embodiment of the present invention where the connection end of a wire has not yet been inserted.

FIG. 3 is an enlarged sectional view along L/N-L/N of FIG. 1, showing the state of the fast-wiring device according to one embodiment of the present invention where the connection ends of wires have been inserted.

FIG. 4A is an internal view according to one embodiment of the electrical accessory incorporating the present invention after removing the upper cover of the housing, along with FIG. 4B, a partially enlarged view showing the structure of the conductive element 2, where the connection end of a wire has not yet been inserted.

FIG. 5A is an internal view according to one embodiment of the electrical accessory of the present invention after removing the upper cover of the housing, along with FIG. 5B, a partially enlarged view showing the structure of the conductive element 2, where the connection end of a wire has been inserted.

FIG. 6 is a perspective view of one embodiment of an electrical accessory incorporating the fast-wiring device according to the present invention.

FIG. 7A, FIG. 7B., and FIG. 7C each show an alternate embodiment of the elastic element.

### DETAILED DESCRIPTION

The invention is described below in detail with reference to typical embodiments and accompanying drawings. Identical reference numerals in various figures indicate the same or similar parts. Although the specification discloses typical embodiments, other embodiments may also exist, which may involve modifications to the embodiments of the specification that do not depart from the spirit and scope of the invention. The following detailed description does not limit the invention, as its scope is defined by the claims and equivalent technical solutions.

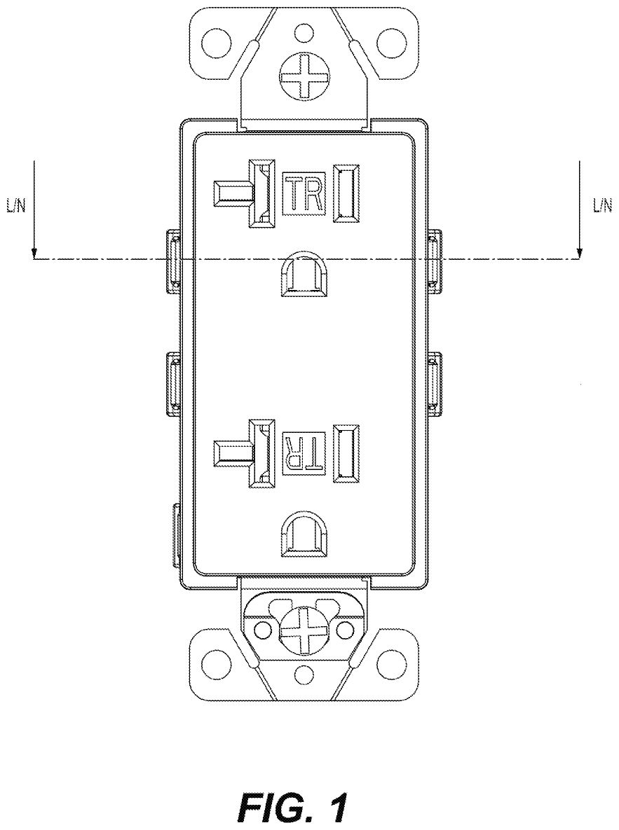

As shown in FIG. 1 to FIG. 3, the fast-wiring device of the invention includes a housing 101, a conductive element 2, an elastic element 3, and a clamping-release mechanism 34. The structure of the housing 101 as shown in the figures may be a single housing or a combination housing comprising an upper cover and a lower cover.

While the fast-wiring device is shown in the context of a power socket and a housing 101 appropriate for a power socket or other electrical receptacles, the fast-wiring device can be integrated in any other wiring application, along with an appropriate housing, such as circuit breakers, power switches, lamps, and other electrical applications The housing 101 comprises a wire insertion port 1011 and conductive element 2 is mounted near the wire insertion port 1011 of the housing 101, ensuring that once the connection end of a wire 4 is inserted in through the wire insertion port 1011, a surface along the length of the wire 4 is in contact with a surface of the conductive element 2, establishing an electrical connection. The conductive element 2 can be a structure in the form of a sheet, or any other structural form that meets the requirement of establishing an electrical connection with wire 4, such as a cylindrical structure.

The elastic element 3 and the conductive element 2 are opposing each other within the housing 101 near the wire insertion port 1011. The elastic element 3 can include an elastic inclined arm 35, which forms a wedge shape with the conductive element 2 along the insertion direction of the wire insertion port 1011. The edge 37 of the elastic inclined arm 35 presses elastically against the conductive element 2, ensuring that once the connection end of wire 4 is inserted through the wire insertion port 1011, the edge 37 of the elastic inclined arm 35 tightly clamps wire 4 to the conductive element 2.

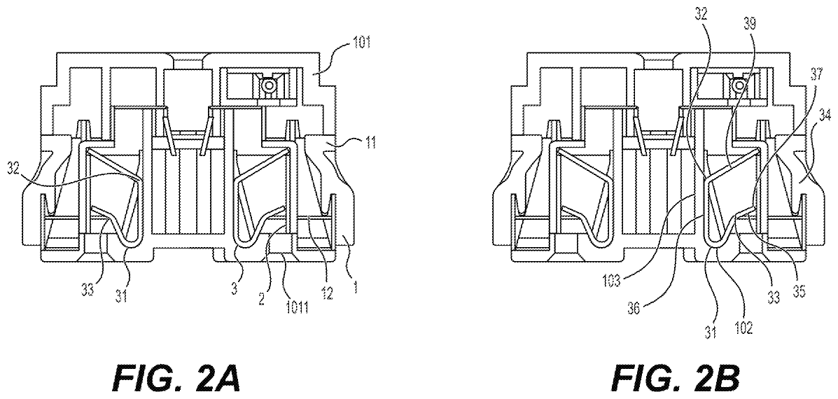

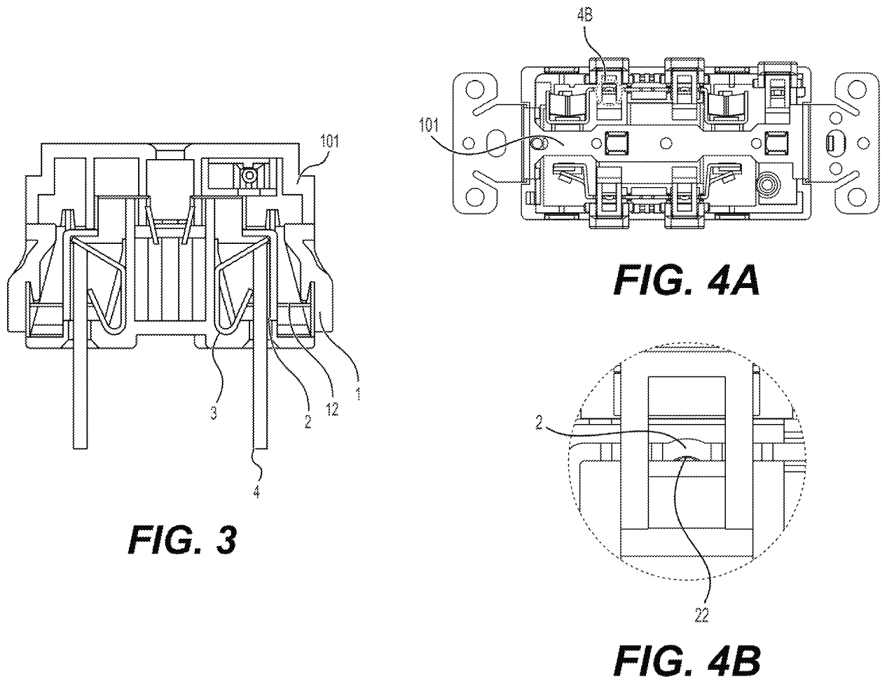

As shown in FIG. 2A and FIG. 2B, in this embodiment, the elastic element 3 adopts a three-bend structure: a first bend 31 generates an elastic clamping force to be applied to wire 4 and is used for positioning of the elastic element 3. The first bend 31 connects the elastic inclined arm 35 of the elastic element 3 with a supporting edge 36, which rests against or abuts a supporting wall 103 of the housing 101, and the first bend 31 is supported on, or abuts, a corresponding bend mounting position 102 in the housing 101. A second bend 32 connects the supporting edge 36 of the elastic element 3 with an extending edge 39, which is electrically connected to the conductive element 2, increasing the contact area for electrical connection with the wire 4, meeting the load requirements of high-current electrical accessories. A third bend 33 is positioned on the elastic inclined arm 35 and is used to increase the elastic clamping force to be applied on the wire 4. The third bend 33 bends in the direction that increases the wedge angle between the elastic inclined arm 35 and the conductive element 2. As shown in FIG. 3, once the wire 4 is inserted, elastic deformation occurs to the elastic inclined arm 35 at the third bend 33, which enhances the clamping force of the elastic inclined arm 35 on the wire 4.

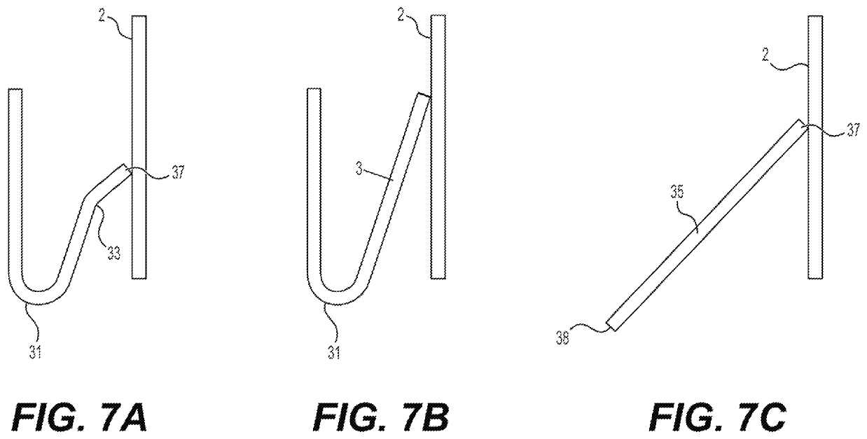

In other embodiments, elastic element 3 can have a two-bend structure. For example, the third bend 33 may be omitted and elastic element 3 can adopt an appearance like that in FIG. 3, while the purposes of this invention can still be achieved, though in this example elastic element 3 would adopt this appearance without the insertion of wire 4. In other embodiments, such as seen in FIG. 7A, the second bend 32 may be omitted, while the purposes of this invention can still be achieved.

In other embodiments, such as seen in FIG. 7B, it is possible to only provide the first bend 31, while the purposes of this invention can still be achieved.

In other embodiments, such as seen in FIG. 7C, the elastic element 3 may only adopt the elastic inclined arm 35, with an end 38 of the elastic inclined arm 35 fixed to the housing 101, as shown in FIG. 2A and FIG. 2B, while the purposes of this invention can still be achieved.

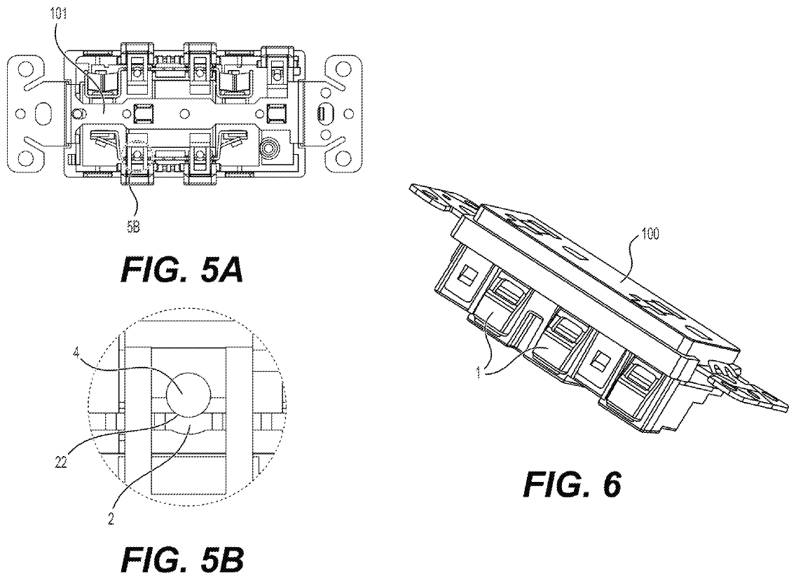

As shown in FIG. 4A, FIG. 4B, FIG. 5A, and FIG. 5B, to increase the contact area between the conductive element 2 and the wire 4, thereby improving the conductive surface between conductive element 2 and wire 4, the conductive element 2 can be provided, on the surface where the conductive element 2 fits with the inserted wire 4, with an arc surface 22 that mates with the surface of the wire 4, such that wire 4 contacts and rests within conductive element 4. This modifies the contact between the conductive element 2 and the wire 4, where the electrical connection surface of the conductive element 2 would otherwise be a flat contact, into an arced contact, significantly increasing the conductive area between the conductive element 2 and the wire 4.

Optionally, arc surface 22 can be characterized as having a radius value that is, or is approximately, one half of the diameter of wire 4. The radius of the arc surface 22 can be set to the radius of a commonly used wire diameter, such as a 1 mm radius for a 2 mm wire. Alternatively, the radius of the arc surface 22 can be set to a middle value, such as a radius of 0.9 mm for a 1.8 mm wire diameter, which is a middle value of the commonly used wire diameters between 1.5 mm and 2.1 mm. And smaller wire diameters, such as 1.5 mm, can also be used.

In the event the radius of the wire exceeds the radius of the arc surface 22, the wire 4 can form two lines of electrical contact at both ends of the arc surface 22 of the conductive element 2, which can also improve the conductive area between the conductive element 2 and the wire 4.

In other embodiments, the conductive element 2 is not provided with the arc surface 22, while the purposes of this invention can still be achieved.

A clamping-release mechanism 34 and the elastic element 3 are arranged on either side of the conductive element 2, with the clamping-release mechanism 34 and the elastic element 3 opposite to each other. The clamping-release mechanism 34 is mounted on the housing 101. With the clamping-release mechanism 34, one can release, or release by use of an external tool, the clamping of the wire 4 by the elastic inclined arm 35 of the elastic element 3.

As shown in FIG. 2A, FIG. 2B, and FIG. 3, in this embodiment, the clamping-release mechanism 34 has the following structure: it includes a button 1, which has a hinged end 11 and a pushing end 12. The button 1 is hinged to the housing 101 via its hinged end 11 and in contact with the elastic inclined arm 35 of the elastic element 3 via its pushing end 12. When the button 1 is pressed, or otherwise engaged, the pushing end 12 lifts the elastic inclined arm 35, releasing clamping of the wire 4 by the edge 37 of the elastic inclined arm 35.

In other embodiments, the clamping-release mechanism 34 can have the following structure: the clamping-release mechanism 34 comprises a button, the button has a pressing guide part (comprising a pressing surface and a guide part) and a pushing part. The pressing guide part fits with a guide slot in the housing 101 to guide the movement of the button. The pushing part fits with the elastic inclined arm 35 of the elastic element 3. When the button is pressed, the pushing part lifts the elastic inclined arm 35 of the elastic element 3, thereby releasing the clamping of the wire 4 by the edge 37 of the elastic inclined arm 35.

In other embodiments, the clamping-release mechanism 34 can have the following structure: the clamping-release mechanism 34 comprises an operation hole on the housing 101. Through this hole, a tool, such as a small screwdriver, can be used to lift the elastic inclined arm 35 of the elastic element 3, releasing clamping of the wire 4 by the edge 37 of the elastic inclined arm 35.

As shown in FIG. 1 and FIG. 6, the electrical accessory 100 of the present invention incorporates features of the fast-wiring device of the present invention as described above.

In this embodiment, the power socket with the fast-wiring device includes ground, live, and neutral wire insertion holes, and the power socket can be extended with one or more additional wire insertion holes.

In other embodiments, the wire insertion holes of the power socket are arranged according to need. For example, only ground, live, or neutral wire insertion holes, or some combination thereof, are incorporated, while the purposes of this invention can still be achieved.

In other embodiments, the electrical accessory of the invention can include, but is not limited to, circuit breakers, power switches, etc.

While a power socket such as a ground fault circuit interrupter (“GFCI”) has been illustrated, the fast-wiring device can be integrated into additional wired electronic devices. For example, the fast-wiring device can be adapted for use in a circuit breaker, switch, or lamp. As an example, it is possible to modify the size or shape of the housing of the circuit breaker or lamp to include the fast-wiring device so that a conductive element and elastic element are mounted near a wire insertion port. The circuit breaker or lamp can optionally comprise a clamping-release mechanism

The above specification describes various embodiments in conjunction with the accompanying drawings. However, it is evident that various modifications and changes can be made without departing from the scope of the claims of this invention, resulting in other embodiments that also achieve the purposes of the invention. Other embodiments achieving the purposes of this invention will be apparent to those skilled in the art based on the disclosed embodiments.

1-10. (canceled)

11. A fast-wiring device, comprising:
a housing comprising a wire insertion port for receiving a wire;
a conductive element mounted in the housing near the wire insertion port, the conductive element configured to contact the wire; and
an elastic element mounted in the housing opposite to the conductive element, the elastic element comprising an elastic inclined arm comprising an edge, the edge configured to press against the conductive element when the wire is not inserted, and the edge configured to press the wire against the conductive element when the wire is inserted.

12. The fast-wiring device of claim 11 wherein the elastic element comprises:
a first bend configured to generate elastic clamping force; and
a supporting edge;
wherein the first bend connects the elastic inclined arm with the supporting edge.

13. The fast-wiring device of claim 12, wherein:
the housing further comprises a supporting wall and a bend mounting position,
the supporting edge abuts the supporting wall, and
the first bend abuts the bend mounting position.

14. The fast-wiring device of claim 12, wherein:
the elastic element comprises a second bend and an extending edge,
the second bend connects the supporting edge to the extending edge, and
the extending edge is electrically connected to the conductive element.

15. The fast-wiring device of claim 14, wherein:
the elastic element comprises a third bend in the elastic inclined arm,
the elastic inclined arm is configured to apply an elastic clamping force against the conductive element, and
the third bend is bent at an angle that increases a wedge angle formed between the elastic inclined arm and the conductive element.

16. The fast-wiring device of claim 12, wherein:
the first bend further comprises an extending edge electrically connected to the conductive element,
the elastic element comprises a second bend in the elastic inclined arm,
the elastic inclined arm is configured to apply an elastic clamping force against the conductive element, and
the second bend is bent at an angle that increases a wedge angle formed between the elastic inclined arm and the conductive element.

17. The fast-wiring device of claim 11, wherein the conductive element is provided with an arc surface, and wherein the arc surface is configured to mate with a surface of the wire when the wire is inserted.

18. The fast-wiring device of claim 11, further comprising a clamping-release mechanism mounted on the housing such that the conductive element is between the elastic element and the clamping-release mechanism, and the clamping-release mechanism is configured to press the elastic element away from the conductive element;
wherein the clamping-release mechanism comprises a button and wherein the button comprises:
a hinged end hinged to the housing, and
a pushing end fitted against the elastic inclined arm,
wherein, when the button is pressed, the pushing end lifts the elastic inclined arm away from the conductive element.

19. The fast-wiring device of claim 11, further comprising a clamping-release mechanism mounted on the housing such that the conductive element is between the elastic element and the clamping-release mechanism, and the clamping-release mechanism is configured to press the elastic element away from the conductive element;
wherein the clamping-release mechanism comprises a button, and wherein the button comprises:
a pressing guide part, the pressing guide part fitting with a guide slot in the housing; and
a pushing part, the pushing end fitted against the elastic inclined arm,
wherein, the pushing part is configured to lift the elastic inclined arm way from the conductive element when the button is pressed.

20. The fast-wiring drive of claim 11, further comprising an operation hole in the housing, wherein the operation hole is configured to receive a tool for pushing the elastic inclined arm away from the conductive element.

21. An electrical accessory comprising the fast-wiring device of claim 11.

22. The electrical accessory of claim 21 comprising a power socket, a circuit breaker, lamp, or a power switch.

23. An electrical accessory, wherein the electrical accessory comprises a live wire hole, ground wire hole, or neutral wire hole incorporating the fast-wiring device of claim 11.

24. The fast-wiring device of claim 17, wherein the arc surface has a radius value that is, or is approximately, one half of the diameter of the wire.

25. The fast-wiring device of claim 17, wherein the radius of the wire exceeds the radius of the arc surface, and wherein the arc surface and the wire form two lines of electrical contact.

26. A fast-wiring device, comprising:
a housing comprising a wire insertion port;
a conductive element mounted in the housing, the conductive element configured to contact a wire inserted through the wire insertion port; and
an elastic element comprising an elastic inclined arm, the elastic element mounted in the housing;
wherein the conductive element is opposite to the elastic element, and
wherein the elastic inclined arm presses elastically against the conductive element when a wire is not inserted, and wherein the elastic inclined arm elastically presses the wire against the conductive element when the wire is present.

27. The fast-wiring device of claim 26, wherein the elastic element comprises a supporting edge; and
a bend between the supporting edge and the elastic inclined arm;
wherein the supporting edge rests against a supporting wall of the housing and the bend generates an elastic clamping force against the wire when the wire is present.

28. The fast-wiring device of claim 26, wherein the elastic element comprises:
an extending edge; and
a bend between the extending edge and the inclined arm,
wherein the extending edge is electrically connected to the conductive element and the bend elastically presses the wire against the conductive element when the wire is present.

29. The fast-wiring device of claim 26, further comprising a clamping-release mechanism configured to lift the elastic element.

30. A fast-wiring device, comprising:
a housing comprising a wire insertion port for receiving a wire, the wire insertion port having a wire insertion direction;
a conductive element mounted in the housing for contacting the wire once the wire has been received; and
an elastic element comprising an elastic inclined arm;
wherein the elastic element is mounted in the housing opposite to the conductive element,
wherein the elastic inclined arm presses against the conductive element when a wire is not inserted, and wherein the elastic inclined arm presses the wire against the conductive element when the wire has been inserted, and
wherein the elastic inclined arm forms a wedge shape with the conductive element along the wire insertion direction of the wire insertion port.
